(19) United States
(12) Patent Application Publication
(10) Pub. No.: US 2003/0035152 A1
(43) Pub. Date: Feb. 20, 2003

(54) Scanning method with two exposure steps

(76) Inventors: Kuo-Jeng Wang, Kaohsiung (TW); Tom-Chin Chang, Da-Pi Hsiang (TW); Rong-Ji Liu, Taichung (TW)

Correspondence Address: J.C. Patents, Inc., Suite 114, 1340 Reynolds Ave., Irvine, CA, 92614, US

(21) Appl. No.: 09/930,844

(22) Filed: Aug. 14, 2001

(51) Int. Cl. H04N 1/04; H04N 1/46

(52) U.S. Cl. 358/474; 358/505; 358/486

(57) ABSTRACT

A scanning method with two exposure steps. A scanning system is driven with a motor. While the motor is stopped after rotating a predetermined distance, the scanning process is started. In the first scanning step, an odd (even) number of pixel video data is obtained. The odd (even) number of pixel video data is compensated as required. In a second scanning step, an even (odd) number of pixel video data is compensated as required. The video data is then output.

### BACKGROUND OF THE INVENTION

1. Field of Invention

The invention relates a scanning method. More particularly, the invention relates to a scanning method with two exposure steps.

2. Related Art

FIG. 1 shows a conventional scanning method. When a charge coupled device (CCD) 100 receives a scanned data, the detected light intensity is converted into a photo current via photoelectric conversion and stored in a storage electrode in the form of signal charge. The signal charge is then converted into a potential difference. Through an analog/digital (A/D) converter 110, the analog signal of the charge couple device 100 is converted into a digital signal. When an application specific integrated circuit (ASIC) 120 receives the scanned data, compensation data is caught from a compensation memory 130. A compensation process is performed on the scanned data. The compensated scanned data is then stored in video memory 140. The data of the video signal is read from the video memory 140 and sent to the input/output (I/O) port 150 to output the scanned data.

However, to increase the video resolution of the scanner, the following problems are encountered. (1) A light adjustment technique is used to resolve the over saturation problem of the detector. Due to long exposure time, the charge couple device is over saturated. For short exposure time, the time for sending a voltage signal from the charge couple device is not enough. (2) The data amount of the voltage signal output from the charge couple device is too large to cause an increase in capacity of the compensation memory and the compensation counter. A higher resolution for a large area scan cannot be supported. (3) The large data amount of the voltage signal output from the charge couple device further increases the required capacity of the video memory.

### SUMMARY OF THE INVENTION

The present invention provides a scanning method with two exposure steps. By processing the video data by means of a different method, the above problems are resolved.

In the invention, a scanning system using a motor for driving is used. When the motor stops after rotating a predetermined distance, the scanning step starts. In the first scanning step, the video data of odd (even) number pixels is obtained and compensated as required. In a second scanning step, the video data of odd (even) number pixels is obtained and compensated as required. The video data is then output.

With this different scanning process, the video data that used to be scanned in one step is scanned in two steps. Therefore, the amount of the video data to be processed becomes one half, so that the required compensation data is reduced to one half as well. The required capacity of the compensation memory and the video memory is thus reduced. By controlling the motor to stop after rotating a predetermined distance, long exposure time is avoided. Consequently, the over saturation of the charge couple device is improved. Also, the problem of insufficient time to output the voltage signal from the charge couple device due to short exposure time is also resolved.

### BRIEF DESCRIPTION OF THE DRAWINGS

These, as well as other features of the present invention, will become more apparent upon reference to the drawings, wherein:

FIG. 1 shows a block diagram of a conventional scanning method; and

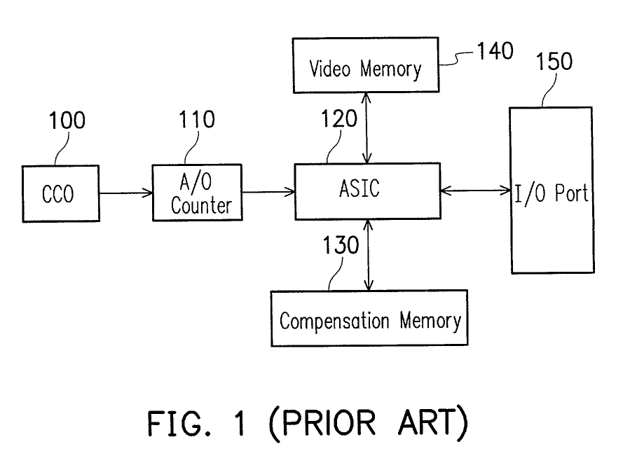

FIG. 2 shows the process flow of the scanning method with two exposure steps.

### DETAILED DESCRIPTION OF THE PRESENT EMBODIMENT

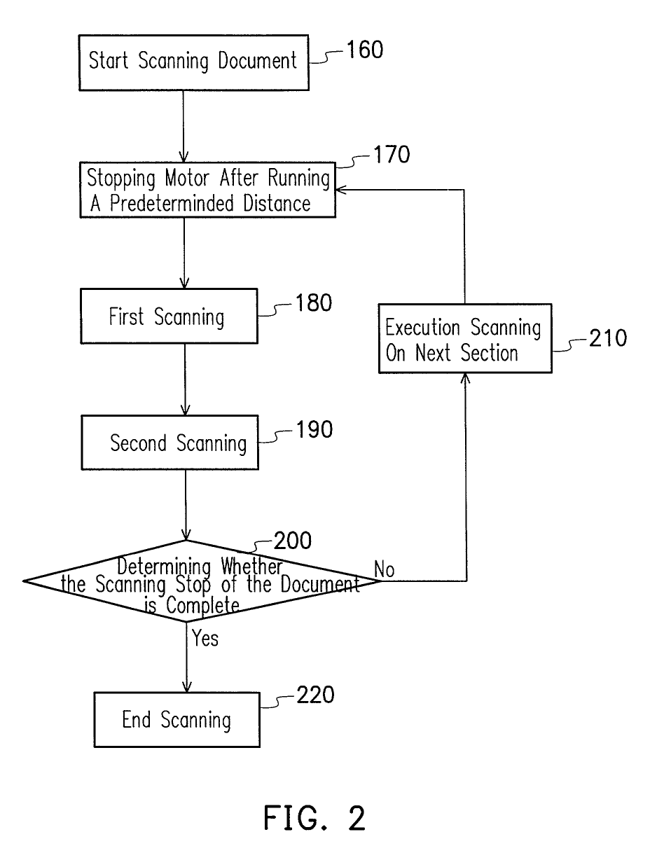

FIG. 2 shows a process flow of the scanning method with two exposure steps.

The invention provides a scanning method with two exposure steps. The method can be applied to a scanning system. One embodiment of the scanning system may include a charge couple device, an analog-to-digital converter, an application specific integrated circuit, a motor, a set of planar mirrors, a set of lenses, a set of filter mirrors, a lamp tube, a video memory, a compensation memory and an input/output port.

When the scanning system starts scanning a document in step 160, the motor stops after rotating a predetermined distance in step 170. The scanning process starts with a first scanning step 180 with a light source emitted from the lamp tube incident to the scanned document. When the light source is incident to the scanned document, the light beam transmitting through or reflected by the scanned document is reflected from the set of planar mirrors to the set of lenses. The light from the set of lenses is then incident and focused on the charge couple device. The set of filter mirrors is disposed between the set of lenses and the charge couple device to filter the light beam, so as to produce red, blue and green primary lights.

When the charge couple device receives the light projected from the set of lenses, the detected light intensity is converted into a photocurrent via photoelectric conversion. The photocurrent stored in a storage electrode is converted into a signal charge, and further transferred into a form of potential. By using the analog-to-digital converter, the signal is converted into a digital signal. The video data for the odd (even) number pixels is processed by the application specific integrated circuit. A compensation data is extracted from the compensation memory to compensate the video data for the odd (even) number pixels. The compensated video data is then stored in the video memory.

The second scanning step (190) is similar to the first scanning step 180. The only difference is that whereas only the video data for the odd number pixels is scanned at the first scanning step 180, only the video data for the even number pixels is scanned in the second scanning step 190, and vice versa.

After the second scanning step, two video data sets are integrated in the application specific integrated circuit to determine whether the scanning for the scanned document is complete in step 200. If the scanning process is not finished, a next section of the scanned document is scanned in step 210. If the whole scanned document has been scanned, the scanning process is over (220).

Therefore, two process steps are performed on the video data. Only one half of the compensation data is required, and the video data to be processed becomes one half as well. The capacity of the compensation memory and the video memory is consequently reduced to one half. Further, as the motor stops after rotating a predetermined distance, the over saturation of the charge coupled device and insufficient time for outputting the voltage signal caused by having the exposure time too long or too short are improved.

The invention thus has at least the following advantages:

1. The over saturation of the charge couple device caused by long exposure time is improved, and the problem of insufficient time for outputting the voltage signal due to short exposure time is also resolved.

2. The required capacity of the compensation memory is reduced.

3. The required capacity of the video memory is reduced.

It is to be further understood that various additions, deletions, modifications and alterations may be made to the above-described embodiments without departing from the intended spirit and scope of the present invention. Accordingly, it is intended that all such additions, deletions, modifications and alterations be included within the scope of the following claims.

What is claimed is:

1. A scanning method with two exposure steps, wherein a scanning system driven by a motor is used, and the scanning system has a charge coupled device, an application specific integrated circuit, an optical apparatus, a lamp tube, a video memory, a compensation memory and an input/output port, the scanning method comprising:
stopping the motor after it rotates a predetermined distance;
converting a scanned data received by the charge couple device into a signal charge;
obtaining and compensating video data of odd number pixels;
obtaining and compensating video data of even number pixels; and
outputting the video data.

2. The scanning method of claim 1, wherein the step of compensating the video data further comprises:
extracting compensation data from the compensation memory to compensate the scanned data when the application specific application circuit receives the scanned data;
storing the compensated scanned data in the video memory; and
extracting the scanned data from the video memory and outputting the scanned data to the input/output port via the application specific integrated circuit.
